(19) United States
(12) Patent Application Publication
(10) Pub. No.: US 2007/0130217 A1
(43) Pub. Date: Jun. 7, 2007

(54) MANY TO MANY DATA SYNCHRONIZATION

(75) Inventors: Ronald A. Linyard, San Diego, CA (US); Mark R. Wineman, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: UNWIRED SOFTWARE, INC., San Diego, CA (US)

(21) Appl. No.: 11/549,525

(22) Filed: Oct. 13, 2006

Related U.S. Application Data
(60) Provisional application No. 60/726,136, filed on Oct. 13, 2005.

(51) Int. Cl. G06F 17/30

(52) U.S. Cl. 707/201

(57) ABSTRACT

The invention allows any number of connected computing devices to synchronization data with each other without being wired directly to each other. The invention provides for generic data handling in addition to type-specific data handling to allow plug-in support for additional data types without altering the basic infrastructure of the system.

### RELATED APPLICATION

The present application claims priority to U.S. provisional patent application Ser. No. 60/726,136 filed on Oct. 13, 2005 which is incorporated herein by reference in its entirety.

### BACKGROUND

1. Field of the Invention

The invention relates to the synchronization of data between multiple computing devices that are communicatively coupled via a communication network.

2. Related Art

Conventional wireless data communications between two devices typically rely on data being stored on a web server. In the conventional solutions, the first device pushes its data to the web server and then during a corresponding subsequent connection the second device pulls the information down from the web server.

In other conventional implementations, the information is pushed from the web server down to the second device. The Blackberry model of reading email on a device is an example of this. Information for a user is stored on a server and periodically pushed out to the Blackberry server, which in turn periodically pushes the information out to the remote Blackberry device. The Blackberry model suffers from its one user-to-one device limitation.

The rapid growth of mobile consumer devices such as the Blackberry have demonstrated that the market has defined a need to share information such as email, calendars, contacts, lists, and data files between multiple mobile devices and multiple desktop devices simultaneously. Furthermore, today's sophisticated and security conscious users demand the ability to share this information without storing it on a web server that is potentially the target of hackers. Accordingly, what is needed is a system and method that overcomes the significant problems found in the conventional systems described above and meets the needs defined by the market.

### SUMMARY

Embodiments of the invention described herein allow a plurality of mobile devices to send, receive, and synchronize data with any number of other devices (other mobile devices and/or desktop devices). The system comprises a web server that is configured to enable communications between devices and provide a data communication path between devices such that the devices can communicate without the need for storing information on the web server. The web server employs plug-ins to resolve data-specific synchronization issues and provide granular merging of data from multiple devices. These plug-ins can be dynamically loaded on the web sever to allow new data types to be identified and synchronized in real time without affecting synchronization of other data types. Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level network diagram illustrating an example system for many to many data synchronization according to an embodiment of the present invention;

FIG. 2A is a block diagram illustrating an example device in a system for many to many data synchronization according to an embodiment of the present invention;

FIGS. 2B and 2C are block diagrams illustrating example synchronization data structures according to an embodiment of the present invention;

FIG. 3 is a block diagram illustrating example functional modules in a synchronization system according to an embodiment of the present invention;

FIG. 4 is a block diagram illustrating an example buddy list for use in many to many data synchronization according to an embodiment of the present invention;

FIG. 5 is a data structure diagram illustrating an example contact record according to an embodiment of the present invention;

FIG. 6 is a flow diagram illustrating an example method for initiating data synchronization according to an embodiment of the present invention;

FIG. 7 is a flow diagram illustrating an example method for authenticating a device requesting data synchronization according to an embodiment of the present invention;

FIG. 8 is a flow diagram illustrating an example method for many to many data synchronization according to an embodiment of the present invention;

FIG. 9 is a flow diagram illustrating an example method for data synchronization with a target device according to an embodiment of the present invention;

FIG. 10 is a block diagram illustrating an example wireless communication device that may be used in connection with various embodiments described herein; and

FIG. 11 is a block diagram illustrating an example computer system that may be used in connection with various embodiments described herein.

### DETAILED DESCRIPTION

Certain embodiments as disclosed herein provide for many to many data synchronization between computing devices connected via wired or wireless communication networks. For example, one method as disclosed herein allows for multiple devices to synchronize data with each other in a fashion that does not require sensitive data to be stored at any intermediate location such as a network based server. Additionally, one embodiment provides for generic data handling and type-specific data handling coupled with dynamic plug-in support that facilitates synchronization of new data types without altering the basic architecture of the system.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

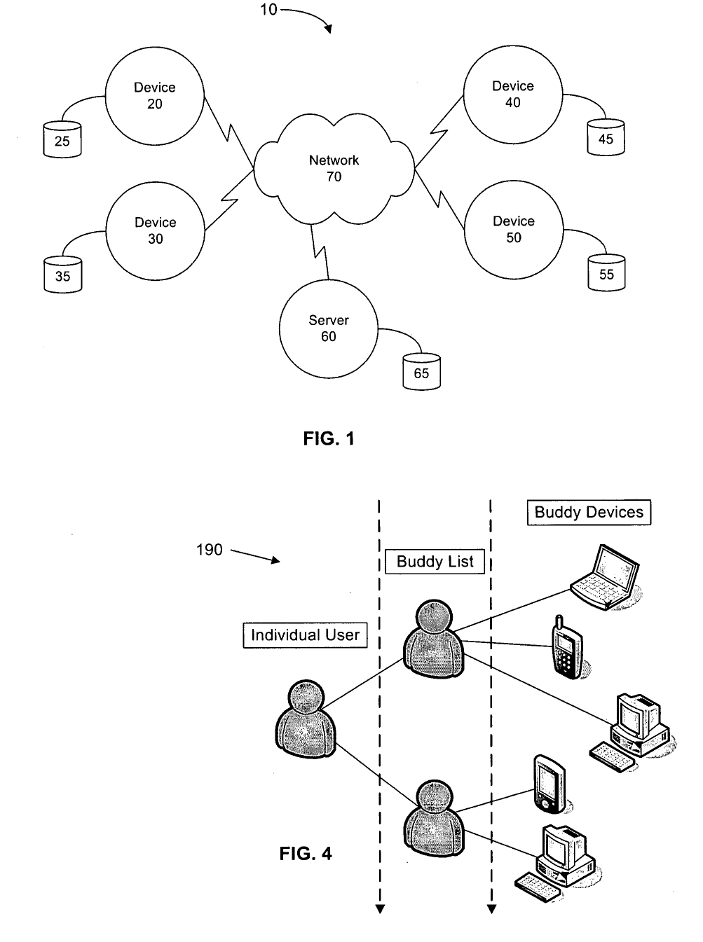

FIG. 1 is a high level network diagram illustrating an example system 10 for many to many data synchronization according to an embodiment of the present invention. In the illustrated embodiment, the system 10 comprises a plurality of devices 20, 30, 40 and 50 that are each communicatively coupled with a server 60 via network 70. Each of the devices are configured with respective data storage areas 25, 35, 45 and 55. The server 60 is also configured with a data storage area 65.

A device in the system 10, for example, device 20, may be any variety of computing platform including a cell phone, smart phone, personal digital assistant (“PDA”), personal computer (“PC”), laptop computer, PC card, special purpose equipment, or any combination of these and other devices capable of establishing communication over network 70 with the server 60. A device 20 may also be referred to herein as a handset, wireless device, mobile device, device, computer, wireless unit, or mobile unit.

The server 60 can also be any of a variety of computing platforms executing any of a variety of operating systems and or database management systems. The server 60 can be a single device or it can be logically spread amongst a plurality of devices that all access a common shared data storage area 65. For example, in one embodiment the server 60 may be implemented as a server farm including multiple separate server devices operating in cooperation to provide data synchronization services. The server 60 may also be referred to herein as a web service.

The network 70 may include a plurality of networks including wired, wireless, private, public, circuit switched, packet switched, personal area networks (“PAN”), local area networks (“LAN”), wide area networks (“WAN”), metropolitan area networks (“MAN”), or any combination of the these. Other network types may also be included as needed to facilitate communication between the various devices and server 60. In one embodiment, the network 70 may include that particular network known as the Internet.

Data storage areas 25, 35, 45, 55 and 65 that are configured with the devices 20, 30, 40, 50 and the server 60, respectively, can be any sort of internal or external memory device and may include both persistent and volatile memories. The function of the respective data storage areas is to maintain data for long term storage and also to provide efficient and fast access to instructions for applications that are executed by the respective devices. In one embodiment, data storage area 65 may be remotely located and accessed by the server 60 through a database server device (not shown).

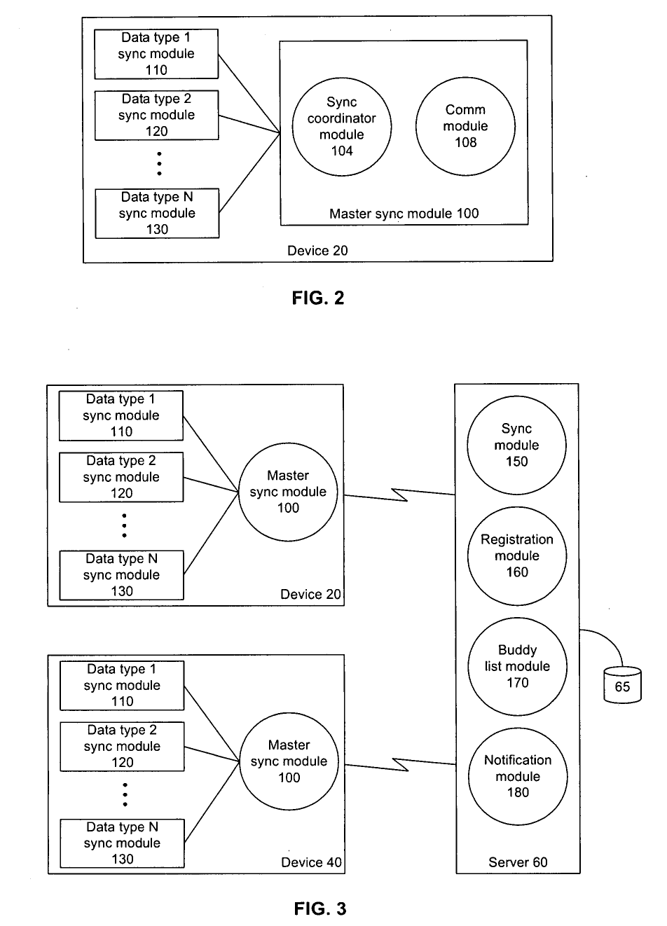

FIG. 2A is a block diagram illustrating an example device 20 in a system for many to many data synchronization according to an embodiment of the present invention. In the illustrated embodiment, the device 20 comprises a plurality of data type sync modules, namely data type 1 sync module 110, data type 2 sync module 120, and data type N sync module 130. There can be any number of data type sync modules, as shown by the inclusion of data type N sync module 130. The various data type sync modules are communicatively coupled with a master sync module 100 that executes on the device 20 and manages synchronization of various data types through the individual data type sync modules such as modules 110 and 120.

In the illustrated embodiment, the master sync module 100 comprises a sync coordinator module 104 and a communication module 108. In one embodiment, the master sync module 100 is configured to coordinate all aspects of synchronization, including establishing and maintaining the communication paths between the server (e.g., a web service) and the remote devices, resolving synchronization conflicts, and using the data type synchronizers to convert between stored data formats on the local device 20 to synchronization-compatible data formats. In the illustrated embodiment, the sync coordinator module 104 may be further functionally divided into an initiating sync coordinator module and a responding sync coordinator module. The description below describes the sync coordinator module 104 as having these separate functional modules.

The communication module 108 is responsible for all aspects of communication during synchronization between the local computer and the web service and remote computers. Advantageously, a version of the communication module 108 resides on both the local computer and the remote computer. Its primary responsibility is to establish a communication pathway between the local computer and the web service and between the local computer and the remote computers with which it is synchronizing.

At the beginning of the synchronization operation, the communication module 108 obtains a list of remote computers with which to synchronize during the current synchronization session. In the case of the initiating computer, this list might already be stored on the local system or it may be stored on the central web service. In addition, the system has the flexibility to allow synchronization with only a subset of the remote computers it is interested in. To determine the remote computers to use for the current synchronization operation, the communication module 108 may prompt the user with the possible list of remote computers and allow the user to select which remote computers he would like to synchronize with. Optionally, the communication module 108 (in “automatic” mode) could choose which remote computers to synchronize with based on many criteria including but not limited to: time of last synchronization with each remote computer, the last time each remote computer was “on line,” general user preferences about which computers the user prefers to synchronize with, time of day and projected load of the remote computers, etc.

As part of the initialization during synchronization the master sync module 100 determines whether the local computer is acting as the initiating device or the responding device in the synchronization process. Although both the initiating device and the responding device act as peers with respect to the priority of their synchronization data, the initiating device drives the communication handshaking and information transfer during the synchronization operation. Therefore, the master sync module 100 invokes the initiating sync coordinator or responding sync coordinator as appropriate.

During synchronization the communication module 108 establishes and maintains the data communication path with the remote computer via the web service. In addition, if the connection between the local computer and the remote computer is broken during synchronization, the communication module 108 may reestablish the connection and continue synchronization without affecting the sync coordinator modules or data type modules.

Maintaining and reestablishing the synchronization connection between computers can be a complex undertaking in the wireless world that is still prone to losing connections. Many different processes can be used to establish and reestablish communication pathways depending on the type of communication used. In one embodiment, the communication module 108 heuristically-determines timeout intervals for establishing when a connection has been lost versus a remote computer that is slow responding. This includes consideration of the amount of data being synchronized and the general communication characteristics of the remote computer (which may be different, for example, for desktop computers versus mobile phones). The communication module 108 may also intersperse “ping” operations in the middle of a synchronization operation to determine if the remote computer is still connected.

The communication module 108 also handles requests to terminate a synchronization operation. This request can occur for a number of reasons, but the most likely is that the user has requested to cancel the synchronization operation. When terminated on the local computer, the communication module 108 is also responsible for communicating the termination request to the remote computer. In addition, the master sync module 100 must clean up all temporary synchronization data and restore the state of the data on the computer to its pre-synchronization condition. This means that the synchronization coordinator modules and the data type modules must operate on temporary copies of the data during synchronization to enable this “rollback” capability.

The communication module 108 is also responsible for validating the legitimacy of connection requests from remote computers. This is very important to maintain the security of the system and avoid a variety of methods hackers may use to infiltrate the system. There are many different techniques to implement those validation steps, as will be understood by those skilled in the art.

The communication module 108 also handles breaking up synchronization information into packets and the subsequent reconstruction of them on the remote computer. This packetization might be necessary to handle data size limitations on mobile devices. In addition, packetization increases the responsiveness of the system to the user during a synchronization operation and improves the reliability of the entire synchronization operation by limiting the amount of data load required to be carried over the communications network.

The communication module 108 handles encrypting and decrypting the synchronization information for transfer between the computers performing the synchronization. This ensures that the data traveling between computers remains secure even if it is intercepted.

The communication module 108 tracks the progress of synchronization throughout the synchronization process and communicates that progress to the master sync module 100 or other control module to inform the user about the progress of synchronization. Depending on the amount of data being synchronized it can be a lengthy process, and it is important that the user has a reasonably accurate representation of the progress. Progress can be reported using thermometer controls or other similar user interface paradigms.

The initiating sync coordinator module and the responding sync coordinator module share much common functionality. Generally, the sync coordinator modules are responsible for merging synchronization information together.

Both sync coordinator modules load all data type synchronizer modules at the appropriate time during synchronization. They also notify the data type synchronizers of synchronization status on behalf of the communication module 108 throughout the synchronization process. These notifications include but are not limited to: synchronization starting, synchronization ending, synchronization aborted, and synchronization complete for each specific type of data being synchronized.

Both sync coordinator modules are configured to identify and use data group members and data item members. In one embodiment, the sync coordinator modules have shared functionality that is not specific to merging information. For example, both sync coordinator modules share functionality to iterate through general sets of data groups and their contained data items. In addition, both sync coordinator modules share functionality to serialize and de-serialize the data group and data item information into formats and character sets that are compatible with network transfer mechanisms. For example, in one embodiment data groups and data items are serialized into extensible markup language (“XML”) streams.

In one embodiment, the sync coordinator modules are each responsible for translation of data type specific information into a common format that can be handled by the master sync module 100. The common format can be a variety of data formats, for example, the data group and data item formats shown in FIGS. 2B and 2C. Other implementations may use XML, customized file formats, shared memory structures or other similar mechanisms for the common data format. The sync coordinator modules are also responsible for type-specific data synchronization when necessary, for example when the master sync module 100 is unable to resolve synchronization issues in the common data format.

In the embodiment shown in FIGS. 2B and 2C, synchronization data is organized into a two level hierarchy of data consisting of data groups and data items. Data groups are the highest level construct and represent collections of data items. Using calendar information as an example, a data group would represent either an entire calendar or a specific period of time (e.g., one week) and then the data items would be individual calendar entries.

Continuing with the discussion of FIG. 2A, the initiating sync coordinator module is responsible for coordinating all data-merging activity for the initiating computer. The initiating computer is the device on which synchronization is initiated and can be used to query the user for additional conflict resolution input during synchronization. The responding computer is the device responding to synchronization requests, and the system assumes there may not be a user in attendance to help resolve synchronization conflicts.

At the start of synchronization, the initiating sync coordinator module tracks the starting and ending times of synchronization. This information is used to correct for time differences between the initiating computer and responding computer as well as tracking when synchronizations occur. This helps the initiating computer determine which pieces of synchronization information have changed since the last synchronization operation.

In one embodiment, the initiating sync coordinator module implements a synchronization state machine on the initiating computer that is used to coordinate the synchronization algorithm in the cases where synchronization may be a multi-stage operation. For example, in a multi-stage operation, a back-and-forth exchange between devices may continue as necessary to resolve all synchronization issues. There are several approaches that can be taken to reach ultimate resolution of all synchronization issues. For example, the initiating device can send all known data to the responding device during the first pass of synchronization; the responding device can resolve all conflicts as described above and return a complete data set back to the initiating device. Generally, to reduce data flow requirements across the network, a multi-pass approach is used where a subset of the data is passed back-and-forth between the initiating device and the responding device. After all sync issues have been resolved, the initiating and responding devices terminate their connections with the web service and the web service removes the entry in the active connections table. In addition, if the data on the initiating or responding devices was changed during synchronization, the device on which the data has been changed can send notification to all other devices it is synchronizing with that updates are available. When that notification is received by a device, it can automatically start a new synchronization session with the appropriate devices to get the updated data.

The initiating sync coordinator module validates the integrity of the synchronization data received from the responding computer. Throughout the synchronization process, the initiating sync coordinator sends specific synchronization data to the responding sync coordinator module and expects responses in defined formats. The initiating sync coordinator module receives those responses from the communication module 108 and performs validation to ensure each response is appropriate.

The main function of the initiating sync coordinator module is to determine which synchronization information received from the responding computer conflicts with the information on the initiating computer and resolving those issues. Synchronization conflicts can occur, for example, when users on both the initiating computer and responding computer have modified the same information in different ways since the last synchronization operation. The initiating sync coordinator module has general algorithms for resolving those conflicts.

For example, synchronization of data groups and data items is a complex task with many variables. One embodiment of the invention sends a subset of the data groups and data items during synchronization. Only entities that have been updated since the last sync need to be communicated. To enable many-to-many synchronization and send only a subset of the data, each entity has a date-time stamp on it representing the last time the entity was modified by a user and the last time it was altered on each local device. By using that information and the information of the last synchronization time for each authorized device being synchronized with, the system can accurately construct the minimal subset of information to send during synchronization.

In addition, by constructing the system to use “generic” data structures for data groups and data items while still communicating the type-specific information (via the XML representation field), the system is able to handle most of the synchronization tasks in a general way while still allowing the type-specific information to be used when necessary to handle sub-item level synchronization. An example of that concept can be seen by considering a typical contact information entry where perhaps the name of the contact, home phone number, mobile phone number, business fax number, and business address are stored. If the home phone number is altered on one device and the business fax number is altered on a different device, it is possible for the system to use the data type synchronizer specific for contact data to combine the information and keep both updated pieces of information. In that case, the common data contains type-specific information in the XML representation where it is clear when the home phone and business fax numbers were last updated on each device. In that case, the data type synchronizer would use that information to merge the data items using the latest home phone and business fax numbers.

Advantageously, when the general algorithm cannot resolve a particular conflict, the initiating sync coordinator module uses the appropriate data type synchronizer to resolve the conflict using data-specific information. The initiating sync coordinator module ensures that each data type synchronizer has an opportunity to provide synchronization data for the synchronization process. In this fashion, all synchronization information on the initiating computer can be synchronized.

The main functions of the responding sync coordinator module are to respond to requests for synchronization data from the initiating computer and coordinate all data merging activity for the responding computer. Similar to the initiating sync coordinator the responding sync coordinator also tracks the starting and ending times of synchronization to help coordinate synchronization activity and account for time differences between the initiating computer and the responding computer. Additionally, the responding sync coordinator implements its own synchronization state machine that corresponds to the state machine in the initiating sync coordinator. Lastly, the responding sync coordinator uses the data type synchronizers on the responding computer to provide synchronization information for the responding computer and resolve data type specific synchronization conflicts.

The various data type sync modules, namely data type 1 sync module 110, data type 2 sync module 120, and data type N sync module 130, collectively support synchronization of existing and additional data types without incorporating changes to the sync coordinator modules. Advantageously, the data type sync modules conform to a common interface expected by the sync coordinator modules. This allows the sync coordinators to operate in a general fashion while still providing data type specific synchronization functionality through the use of data type sync modules. Additionally, a plug-in architecture is provided that facilitates synchronization of new data types dynamically such that a new data type sync module is obtained and executed by a device on an as needed basis. These new data type sync modules may be obtained from the web service or from an alternate location.

In one embodiment, a data type sync module such as data type sync module 110 is configured to return the data type handled by the data type sync module. This is used by the sync coordinator modules to ensure that the correct data types are handled by the correct data type sync module. Advantageously, each data type sync module is configured to provide a unique identifier for the specific type of data it handles.

Additionally, the various data type sync modules are configured to determine whether a specified user is authorized access to the data provided by the data type sync module. Although a user may have appropriate authority to synchronize with a given computer, that user may only have authorization for some of the data types stored on that computer.

Additionally, the various data type sync modules are configured to determine which users have access to given data groups or data items. Similar to authorization for a given data type, this functionality provides even more fine-grained access security. Data type sync modules are also configured to return a given data group identified by a specified data group id (assuming access is authorized for the specified user). Data type sync modules can also be configured to return all data groups provided by the data type sync module (and authorized for access by the specified user) and resolve synchronization conflicts for a given data group. This resolution function may also return the status of that resolution so the calling sync coordinator module knows what information to communicate to the remote computer.

Data type sync modules are also configured to resolve synchronization conflicts for a given data item. This function also returns the status of that resolution so the calling sync coordinator module knows what information to communicate to the remote computer. Data type sync modules are also configured to persist synchronization changes back into the data-specific database accessed by the data type sync module. Data type sync modules are also configured to return the last time the data type sync module successfully committed data from a synchronization operation. This allows the calling sync coordinator to minimize the data it requests from the data type sync module for synchronization.

Data type sync modules are also configured to return all users and/or remote computers the data type sync module expects to synchronize data with. In addition, this function also tells the sync coordinator what to do when new remote computers and/or users attempt to synchronize with its data. Data type sync modules are also configured to receive notification when the synchronization operation begins. This allows the data type sync module to initialize its data and retrieve information from its data store.

Data type sync modules are also configured to receive notification when the synchronization operation is complete. This allows the data type sync module to clean up temporary data and write all synchronization data to the type specific data store. Data type sync modules are also configured to receive notification when synchronization is aborted for any reason. This allows the data type sync module to clean up temporary data.

FIG. 3 is a block diagram illustrating an example server 60 in a system for many to many data synchronization according to an embodiment of the present invention. In the illustrated embodiment, the server 60 is communicatively coupled with a device 20 and a device 40. As shown, the server 60 comprises a sync module 150, a registration module 160, a buddy list module 170, and a notification module 180. The server 60 is also configured with a data storage area 65, as previously described. In alternative embodiments, the server 60 may be implemented as a stand alone device or in a server farm environment, either of which can use local or remote storage areas or a combination of the two.

The synchronization module 150 is configured for facilitating a synchronization operation between one or more devices. In the peer-to-peer configuration, the synchronization module 150 is responsible for authenticating, authorizing and placing in contact the two devices involved in any single synchronization event. In the hosted configuration, the synchronization module 150 has the added responsibility of acting as the responding device (as described in paragraph 24 of the provisional patent) of the synchronization event. In the hosted configuration, a single synchronization event takes place directly between the initiating device and the web service.

Whether or not the synchronization is taking place between two remote devices using the web service as a pass through proxy, or in the case where the web service is actively participating in the synchronization event as the responding device. In one embodiment, synchronization can occur when a user of a device (or the system) initiates a synchronization request. The user can initiate a synchronization request by invoking a command on a device. The system may use a variety of criteria for determining when to automatically invoke synchronization. For example, if data is updated on a device the system could automatically detect that update and initiate a synchronization request. Or the system could have a predefined schedule of synchronization times. When the sync request is made the user or system identifies the other (responding) devices with which it wants to synchronize. The master synchronizer on the initiating device contacts the web service via a wireless network (e.g., the internet) with the identifier of the initiating device and the identifier of the first of the responding devices. The web service determines if the request is allowable and if so sends a sync request along with a sync ticket to the master synchronizer on the responding device. Note, in another embodiment of the invention, the web service might instead send a different kind of message to the responding device signaling that it should start up its synchronization software to prepare the master synchronizer for such a request. In either case the web service creates an entry in its active connections table in order to prevent other conflicting synchronization requests from being processed. In response to the synchronization request the responding device communicates back to the web service that it is prepared for synchronization, and the web service notifies the initiating device to proceed and communicates to it the same sync ticket given to the responding device. Note, this initial “handshaking” between the web service, the initiating device, and the responding devices, could be either a single-pass or multi-stage operation where several communications are sent back and fourth. Once the connection between the initiating device and responding devices is made, the web service may keep state-tracking information as the synchronization progresses.

The master synchronizer on the initiating device requests data to be synchronized from one or more of the data type synchronizers on the initiating device. Data type synchronizers are generally stored in a common location, or references to them are stored in a common place which the master synchronizer can access. One possible implementation on a Microsoft Windows® based computer system is to have the locations of all available data type synchronizers stored in a common registry key. When a data type synchronizer for a new data type is available, a reference is added for the new data type synchronizer to the common registry key, and the master synchronizer will automatically load the data type synchronizer. Each data type synchronizer converts its type-specific data into the common format using the formats similar to those specified above as data groups and data items. The data type synchronizer can either generate the common format on-the-fly when the data is requested or have the data already converted and stored to improve performance during synchronization. The master synchronizer sends the synchronization information and the sync ticket it was given earlier to the web service. The web service, based on the sync ticket, knows which responding device to pass the sync information along to, and it does so.

When the master synchronizer on the responding device receives the sync information from the web service, it gathers the same type of sync information from the data type synchronizers on its device then combines that sync information with the information it received from the web service. The combining can be any of a variety of algorithms known to those skilled in the art. An example is given here. Most synchronization issues can be handled by the master synchronizer itself because the information necessary to resolve conflicts is held in the common data format. For example, if a data item has been modified on both the initiating device and on the responding device, a simple algorithm could be to look at the user modified date for the data item on each device and take the one that is most recent. More complex synchronization scenarios might require type-specific conflict resolution. See the description below for type-specific conflict resolution. If there is such a type-specific conflict resolution to be performed, the master synchronizer calls the appropriate data type synchronizer to resolve the conflict using the type-specific data in the xml representation field of the data item.

The master synchronizer on the responding device then sends response information to the web service to be passed along to the initiating device. This back-and-forth exchange continues as necessary to resolve all synchronization issues. There are several approaches that can be taken to reach ultimate resolution of all synchronization issues. For example, the initiating device can send all known data to the responding device during the first pass of synchronization; the responding device can resolve all conflicts as described above and return a complete data set back to the initiating device. Generally, to reduce data flow requirements across the wireless network, a multi-pass approach is used where a subset of the data is passed back-and-forth between the initiating device and the responding device. Such an approach can be constructed by someone skilled in the art. After all sync issues have been resolved, the initiating and responding devices terminate their connections with the web service and the web service removes the entry in the active connections table. In addition, if the data on the initiating or responding devices was changed during synchronization, the device on which the data has been changed can send notification to all other devices it is synchronizing with that updates are available. When that notification is received by a device, it can automatically start a new synchronization session with the appropriate devices to get the updated data.

During the synchronization process described above, the web service may store tracking information about the state of synchronization, the number of times data has been communicated between the initiating device and the responding device, status of security during synchronization, and other state information.

The device registration module 160 is configured for validating license keys and registering devices and authorized users of the system. In one embodiment, devices register with the device registration module 160 before participating in a synchronization operation. Upon subsequent utilization of the system, devices are validated using the device registration module 160 to ensure that they are valid (i.e., the device is registered and license key is valid and unexpired for the device).

The buddy list module 170 is configured for storing and retrieving buddy lists and all of the devices associated with each and every buddy (i.e., registered user) in the system. The buddy list module 170 is responsible for providing a complete list of potential registered users (i.e., buddies) associated with each and every individual user of the system. In one embodiment it is possible for a user not to have a buddy list. In this case, the user will not be able to share and synchronize data with any other registered users of the system. A buddy list, unique to each user of the system, is available and can be used by any user of the system to select which subset of users to share and synchronize information with. The buddy list module 170 is also responsible for providing the web services with a complete list of the devices involved in any specific synchronization operation. This list is used to ensure that for any given synchronization event, all of the buddies (i.e., users) and their associated devices are included.

The notification module 170 is configured for sending out alert messages to one or more devices. These alert messages are sent to a device whenever data that a particular device (or user when utilizing buddy lists) subscribes to is modified. The messages sent by the notification module 170 may have a variety of purposes. For example, an alert message can arrive as a simple informational message alerting the user of a device that some information has changed. Alternatively, the alert message can trigger an automated synchronization operation.

In an alternative embodiment, there may also be a database module (not shown) that is configured for communicating with the physical data store located on a physical storage device used to house the data utilized by the web service. The database module can be configured for accessing a local data storage area, a remote data storage area, or querying a local or remote database management system to obtain the needed data. The database module is also configured for communicating with a specific physical data store and providing the web service with the data it requires in a format that it can understand.

In an alternative embodiment, (separate from the previously described peer-to-peer functionality facilitated by the web service in which the web service acts as a pass through proxy and is primarily responsible for authenticating, authorizing and facilitating synchronization between two or more devices) the web service may also be configured to take on the identity of a responding device. In such a hosted embodiment, the synchronization data is stored on the web server.

In the hosted embodiment, the web service stands in for a synchronizing device when receiving synchronization requests and (acting in the capacity of the responding device) engages in synchronizing data with the initiating device in a manner similar to that of the previously described peer-to-peer embodiment. This hosted embodiment can also be extended to many-to-many synchronization in which the web service takes on the role of many responding devices and is an active participant in the synchronization operation. This provides an additional advantage where each device may only need to sync with the web service (standing in for each responding device).

FIG. 4 is a block diagram illustrating an example buddy list 190 for use in many to many data synchronization according to an embodiment of the present invention. In one embodiment, a Buddy List allows a registered user of the system to define a list of other registered users of the system that they may wish to synchronize data with. A Buddy List contains a specific list of registered users of the system defined by a given user. Different users of the system may, and most likely will, have different buddy lists.

Buddy Lists are created by a user of the system on any one of their registered devices. The underlying data of the Buddy List is stored on the local device for quick retrieval and off-line usage, as well as on the web server via the web service when a connection to the web service is available. Once the Buddy List is created and has been stored on the web server, it is available to the user on any one of his registered devices. For off-line use, the Buddy Lists are synchronized across all of a given user's devices utilizing the same mechanisms used for synchronizing all other types of data described throughout the invention.

In one embodiment, when a user creates some information they wish to share and synchronize with other users of the system, they will associate one or more users from their Buddy List with the information to be synchronized. The user may make this association by invoking an application dialog that allows her to select any number of

| Buddies: | Users: | Devices: | User Devices: |
|---|---|---|---|
| User ID | User ID | Device ID | User Device ID |
| Buddy ID | User Name | Device Type | User ID |
| | | Device Number | Device ID |
| | | SMS Address | |

registered users from her Buddy List. The user can also add additional registered users of the system to her Buddy List at this time. When the user invokes the Buddy List dialog, the system will retrieve the Buddy List information from the data store used by the Web Services if a connection to the web service is available or from the local store if a connection with the web service is not available. The association of Buddy List Users to a given piece of information can be stored in a variety of ways. In one embodiment, the list of users who have access to a given piece of information may be stored within the information (to be synchronized) itself.

Because each registered user of the system is associated with one or more devices, a given Buddy List also indirectly provides the complete list of devices that are associated with a given piece of information for a given synchronization event. This information allows the system to synchronize a given piece of information with, and/or send a notification message to, all of the devices for all of the “buddies” identified by the user.

Using a Buddy List to enable a user of the system to share information with other registered users of the system is advantageous for two reasons: First, it provides a user-friendly way of identifying users to whom information second, it provides a user-friendly way of associating all of a recipient user's devices with a single identifier.

In one embodiment, to construct and maintain Buddy Lists for users of the system, the web service may store information about which registered users make up one or more buddy list for any given user of the system. Furthermore, the web service may store the list of devices that are associated with any given registered user. In one embodiment, the data structures accessed by the web service that are used are: t,0210

In one embodiment, the Buddies table represents associations between users of the system and the other registered users of the system they may synchronize data with. The User ID is the same as the User ID from the Users table creating a “relation” between the Buddies and Users tables. This field identifies the owner of a buddy list. The Buddy ID is the same as the User ID from the Users table. This field identifies the registered users that are associated with a given buddy list.

In one embodiment, the Users table represents the entire list of Registered Users that are allowed in the system. The User ID is a unique identifier for a user of the system. The User Name contains a user-friendly textual representation for the user (e.g., “Mark” or “Tom124”). An example of how to create a unique identifier for a user include, but are not limited to, using a database's Globally Unique Identifier (GUID) field type to automatically generate the value.

In one embodiment, the Devices table represents the entire list of Registered Devices that are registered in the system. The Device ID is a unique identifier for a device in the system. The Device Type contains an identifier that defines the type of device this entry represents (e.g., “Desktop” or “Mobile Device”. The Device Number is the phone number of a device (if appropriate for the device type). The SMS Address is the Short Message Service (SMS) Address for sending SMS (Text) messages to a device (if appropriate for the device type). An example of how to create a unique identifier for a device include, but are not limited to, using a database's Globally Unique Identifier (GUID) field type to automatically generate the value.

In one embodiment, the User Devices table contains associations between users of the system and their devices. The User Device ID is a unique identifier for a user/device pairing. The User ID is the same as the User ID from the Users table. The Device ID is the same as the Device ID from the Devices table. An example of how to create a unique identifier for a user/device pairing include, but are not limited to, using a database's Globally Unique Identifier (GUID) field type to automatically generate the value.

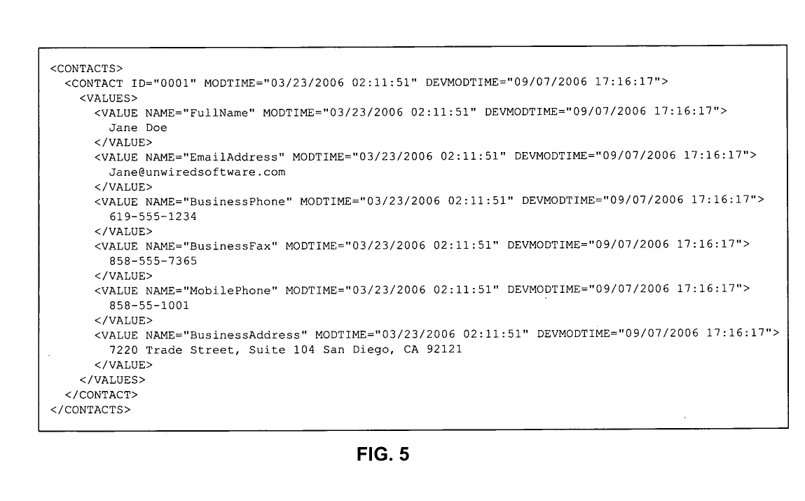

FIG. 5 is a data structure diagram illustrating an example contact record according to an embodiment of the present invention. In alternative embodiments, contact records for buddies and other users can include a variety of demographic information about the person and may be structured in an XML format or the like. The contact record advantageously allows the system to identify an individual and the various devices that the individual may use.

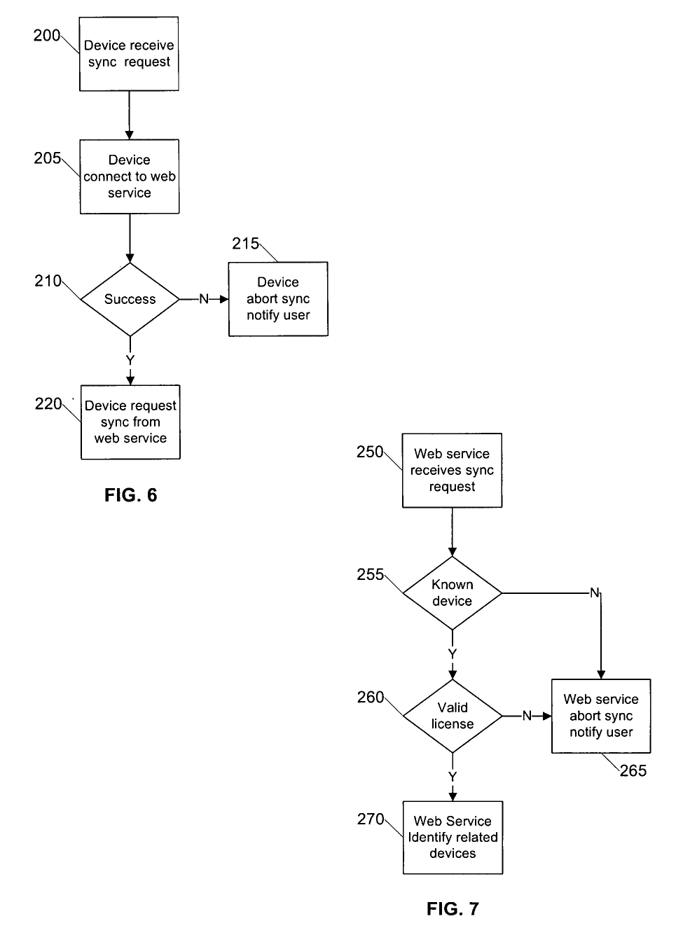

FIG. 6 is a flow diagram illustrating an example method for initiating data synchronization according to an embodiment of the present invention. This process may be carried out by a device or server such as previously described with respect to FIGS. 2A and 3. Initially, in step 200 the device receives a sync request from a user. Next, in step 205 the device connects to the web service. If the connection is not successful, as determined in step 210, the device aborts the requested sync process in step 215 and informs the user accordingly. If the connection is successful, the device requests synchronization from the web service, as shown in step 220.

FIG. 7 is a flow diagram illustrating an example method for authenticating a device requesting data synchronization according to an embodiment of the present invention. This process may be carried out by a device or server such as previously described with respect to FIGS. 2A and 3. Initially, in step 250 the web service receives a sync request from a device. Next, instep 255 the web service confirms that the device is a known device. If the device is known, then in step 260 the web service confirms that the device has a valid license for synchronization services. If the device is not known, as determined in step 255, or the device is not licensed, as determined in step 260, the device aborts the requested sync process in step 265 and informs the user accordingly. Alternatively, if the known device is licensed, then the web service begins the sync operation by identifying the related devices, as shown in step 270.

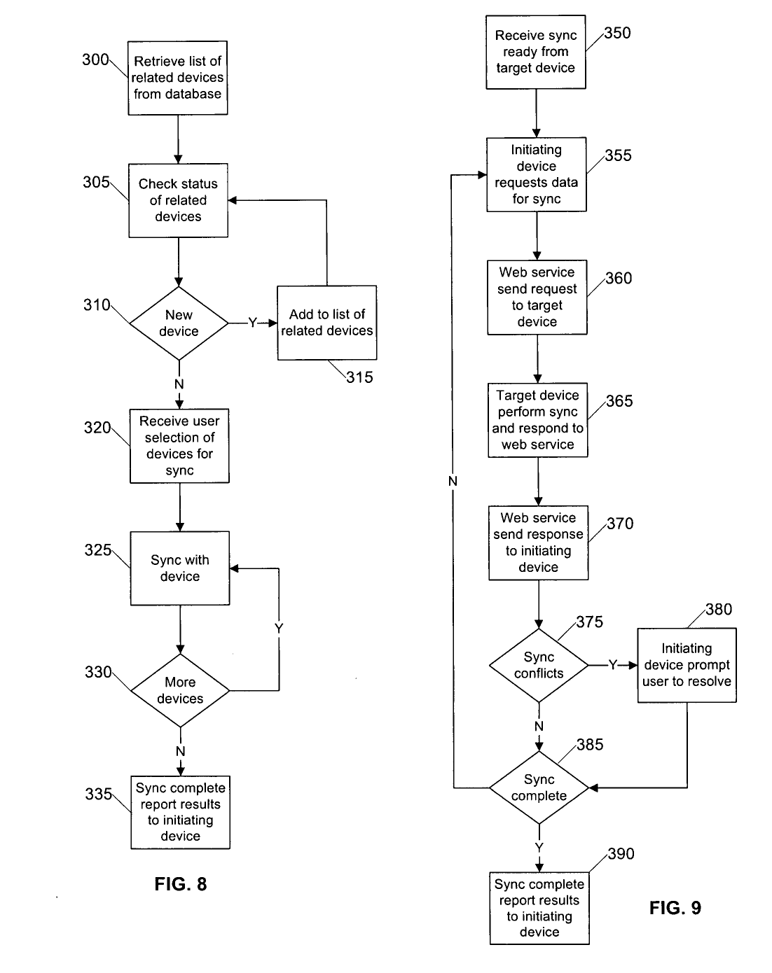

FIG. 8 is a flow diagram illustrating an example method for many to many data synchronization according to an embodiment of the present invention. This process may be carried out by a device or server such as previously described with respect to FIGS. 2A and 3. Initially, in step 300 the web service obtains a list of related devices. This list may be obtained from a database or other data storage such as a flat file or other data structure. For example, the list may be obtained from the previously described buddy list data structures. Next, in step 305 the web service checks the status of the related devices to ensure that they are available for synchronization. Next, in step 310 the web service determines if the user has requested that any new devices be added to the list of related devices. This can be done interactively with the user or the user may provide that information as part of the initial (or a subsequent) request. If there are new devices, the web service adds those devices to the list in step 315 and circles back to step 305 to determine the status of these devices.

Next, in step 320, the web service receives a selection from the user that identifies those specific devices with which the user wants to synchronize. Then in step 325 the web services initiates the sync operation (described in detail later with respect to FIG. 9). If more devices are to be synchronized with, as determined in step 330, then the web service loops back to step 325, reiteratively until synchronization with all of the selected devices is complete. Finally, in step 335, the web service reports the results of the completed sync operations to the initiating device.

FIG. 9 is a flow diagram illustrating an example method for data synchronization with a target device according to an embodiment of the present invention. This process may be carried out by a device or server such as previously described with respect to FIGS. 2A and 3. Initially, in step 350 the web service receives an indication from the target device (also called the responding device) that it is ready to synchronize. Next, in step 355 the initiating device requests the data for synchronization. Next, in step 360 the web service sends the request from the initiating device to the target device. Next in step 365 the target device performs the requested sync operation and sends the responsive results to the web service. Then in step 370 the web service sends the responsive results along to the initiating device.

If there are any synchronization conflicts, as determined in step 375, then the initiating device may prompt the user to resolve the conflict, as shown in step 380. Alternatively, if there are no conflicts, then if the sync is not complete, as determined in step 385, the process loops back to step 355 where the initiating device requests additional data for synchronization. If, however, the sync is complete, then in step 390 the results of the successful sync operation are reported to the initiating device.

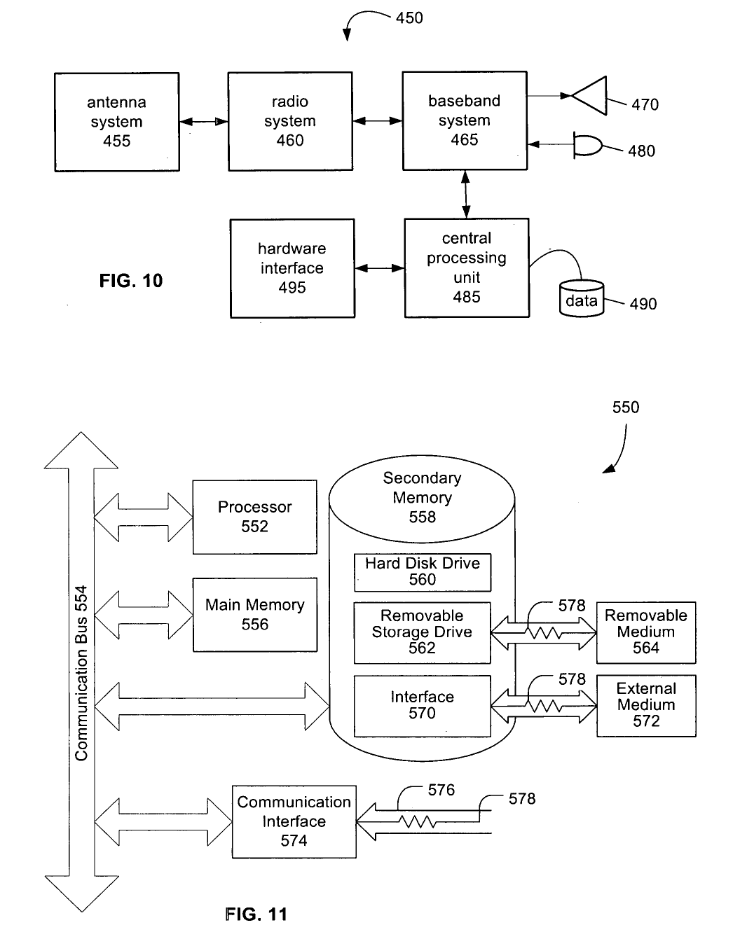

FIG. 10 is a block diagram illustrating an example wireless communication device 450 that may be used in connection with various embodiments described herein. For example, the wireless communication device 450 may be used in conjunction with a device or a server as previously described with respect to FIG. 3. However, other wireless communication devices and/or architectures may also be used, as will be clear to those skilled in the art.

In the illustrated embodiment, wireless communication device 450 comprises an antenna system 455, a radio system 460, a baseband system 465, a speaker 464, a microphone 470, a central processing unit (“CPU” 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) that were previously described with respect to FIGS. 2A and 3.

In this description, the term “computer readable medium” is used to refer to any media used to provide executable instructions (e.g., software and computer programs) to the wireless communication device 450 for execution by the central processing unit 485. Examples of these media include the data storage area 490, microphone 470 (via the baseband system 465), antenna system 455 (also via the baseband system 465), and hardware interface 495. These computer readable mediums are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 11 is a block diagram illustrating an example computer system 550 that may be used in connection with various embodiments described herein. For example, the computer system 550 may be used in conjunction with a device or a server as previously described with respect to FIG. 3. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A computer implemented method for many to many data synchronization between a plurality of devices, comprising:
receiving a synchronization request from a first device;
identifying a plurality of devices that are related to the first device;
receiving a list of target devices comprising a portion of the plurality of related devices;
determining for each of the target devices in the list a current communication status, wherein the current communication status is either available or unavailable; and
facilitating a synchronization process between the first device and each of said target devices having a current communication status of available.

2. The method of claim 1, further comprising updating each of the target devices to provide for many to many data synchronization.

3. The method of claim 1, wherein the synchronization process comprises:
receiving an identification of one or more data groups on the first device to be updated;
merging like data groups from the target devices to produce a synchronized data group; and
updating the first device and each of the target devices with the synchronized data group to provide many to many data synchronization.

4. The method of claim 1, wherein the first device and the target devices are communicatively coupled via a data communication network.

5. The method of claim 4, wherein the data communication comprises a wireless communication link.

6. The method of claim 1, wherein the first device and the target devices are communicatively coupled via a direct wireless link.

7. The method of claim 1, wherein the first device and the target devices are communicatively coupled via a direct wired link.

8. The method of claim 1, wherein the list of target devices is derived from a buddy list on the first device.

9. The method of claim 8, wherein the buddy list comprises a plurality of buddies.

10. The method of claim 9, wherein each buddy in the buddy list comprises one or more buddy devices.

11. The method of claim 10, wherein each buddy device in the buddy list comprises a unique identifier.

12. A computer readable medium having stored thereon one or more sequences of instructions for causing one or more microprocessors to perform the steps for many to many data synchronization, the steps comprising:
receiving a synchronization request from a first device;
identifying a plurality of devices that are related to the first device;
receiving a list of target devices comprising a portion of the plurality of related devices;
determining for each of the target devices in the list a current communication status, wherein the current communication status is either available or unavailable; and
facilitating a synchronization process between the first device and each of said target devices having a current communication status of available.

13. The method of claim 12, further comprising updating each of the target devices to provide for many to many data synchronization.

14. The method of claim 12, wherein the synchronization process comprises:
receiving an identification of one or more data groups on the first device to be updated;
merging like data groups from the target devices to produce a synchronized data group; and
updating the first device and each of the target devices with the synchronized data group to provide many to many data synchronization.

15. The method of claim 12, wherein the first device and the target devices are communicatively coupled via a data communication network.

16. The method of claim 15, wherein the data communication comprises a wireless communication link.

17. The method of claim 12, wherein the first device and the target devices are communicatively coupled via a direct wireless link.

18. The method of claim 12, wherein the first device and the target devices are communicatively coupled via a direct wired link.

19. The method of claim 12, wherein the list of target devices is derived from a buddy list on the first device.

20. The method of claim 19, wherein the buddy list comprises a plurality of buddies.

21. The method of claim 20, wherein each buddy in the buddy list comprises one or more buddy devices.

22. The method of claim 21, wherein each buddy device in the buddy list comprises a unique identifier.

23. A communication device configured for many to many data synchronization, comprising:
a master sync module having a sync coordinator module and a communication module, wherein the sync coordinator module is configured to manage a plurality of data type sync modules to carry out synchronization of data between two or more communication devices, said data having a plurality of discrete data types, and wherein the communication module is configured to communicate with a remote communication device via a data communication network; and
a plurality of data type sync modules, wherein each of the plurality of data type sync modules is configured to process a discrete type of data and synchronize data of said discrete type between two or more communication devices in cooperation with the sync coordinator module and the communication module.
